(19) United States
(12) Patent Application Publication
(10) Pub. No.: US 2012/0236881 A1
(43) Pub. Date: Sep. 20, 2012

(54) PULSED FIBER LASER

(75) Inventors: Thomas Nikolajsen, Slangerup (DK); Peter M.W. Skovgaard, Birkerod (DK)

(73) Assignee: NKT PHOTONICS AS, BLOKKEN 84 (DK)

(21) Appl. No.: 13/391,342

(22) PCT Filed: Aug. 30, 2010
(86) PCT No.: PCT/DK10/50224

§ 371 Date: Jun. 5, 2012

(30) Foreign Application Priority Data
Aug. 28, 2009 (DK) PA 2009 00974

(51) Int. Cl. H01S 3/067; H01S 3/30

(52) U.S. Cl. 372/3; 372/6

(57) ABSTRACT

A method and a laser system for generating a pulsed laser signal with a laser signal wavelength and a laser signal repetition rate, the laser system includes a fiber laser unit includes a cladding pumped fiber laser includes a fiber laser light guiding region surrounded by a pump cladding, the fiber laser light guiding region includes at least one active element; at least one pump laser unit for launching a pump signal into the cladding pumped fiber laser, the pump signal unit includes at least one pump diode emitting a signal at a pump signal wavelength; and a modulating unit for modulating the pump signal into a plurality of pump pulses.

The present invention relates to a super continuum source, a pulsed fiber laser, a method of generating a super continuum, and method for generating a pulsed laser signal.

Relaxation oscillations may occur in a fiber laser when it is in an unstable mode, such as when the laser is run slightly above threshold in CW mode or immediately after the laser is switched on or a pump pulse has been launched into the fiber laser.

Due to the long excited state lifetime of the active rare earth ions in the fiber laser, a time delay typically occurs from the pump laser is switched on or a pump pulse has been launched into the fiber laser until laser action occurs. In this time delay the inversion in the fiber builds up to a level much higher than the inversion level at laser threshold. The bulk part of the energy stored in the fiber via the high inversion is typically released in the first pulse of the relaxation oscillations (termed spiking, the leading pulse or the leading edge). Gating the pump pulse to isolate such a leading pulse of the relaxation oscillations is termed gain switching.

In US 2010/0172381 a method is described where a trigger pulse is applied to the gain medium to control the time at which the first spike takes place. Such pulsed system is complicated for at least two reasons: 1) accurate electronic control of the temporal behaviour of the pump and trigger modules is required, as the timing between the pump pulse and trigger pulse is critical, and 2) optical access for both the pump and the trigger is needed which means that an optical coupler (such as an WDM or a fused pump combiner with signal feed-through) is needed.

The invention relates to a system for gain switching of a cladding pumped fiber laser device for generating a pulsed laser signal with a laser signal wavelength and a laser signal repetition rate. The invention further relates to the combination of such a gain switched cladding pumped fiber laser with a nonlinear fiber for generation of super continuum light.

One object of the invention is to provide a laser system for generating a pulsed laser signal with a laser signal wavelength and a laser signal repetition rate, said laser system comprising a fiber laser unit comprising a cladding pumped fiber laser comprising a fiber laser light guiding region surrounded by a pump cladding. The fiber laser light guiding region comprises at least one active element. The laser system further comprises at least one pump laser unit for launching a pump signal into said cladding pumped fiber laser, said pump laser unit comprising at least one pump diode capable of emitting a pump signal at a pump signal wavelength. The laser system furthermore comprises a modulating unit for modulating said pump signal into a plurality of pump pulses. The modulating unit is arranged to modulate said pump laser unit and/or said pump signal in such a manner that the energy of the individual laser pulses of said pulsed laser signal is substantially confined to the leading pulse of relaxation oscillations of said cladding pumped fiber laser generated in response to each pump pulse.

If the pump laser is suddenly turned on and applied to the fiber laser, lasing action will occur after a time delay. This delay depends on several factors. One factor is the spontaneous emission lifetime as mentioned above. Other factors are optical round trip time in the fiber laser cavity and photon lifetime, which both relates to the Q-factor of the cavity. The power of the pump laser is also a factor, as this determines the gain level in the cavity: the more energetic pump laser, the shorter delay time before the first spike. During this delay time, the pump light results in a build-up of excited rare earth ions and thus in the build-up of inversion.

When the inversion and gain is are present, fluorescence light start starts building up through amplification (ASE, Amplified Spontaneous Emisison) until the first spike finally occurs. This first spike essentially depletes the inversion, so if the pump is turned off at the time of the spike, only one pulse is emitted per pump pulse.

In this way, a simple and economical solution is achieved in that the system is self-triggered: if the pump pulse is turned off before the first spike takes place, ASE within the fiber laser cavity will trigger the pulse emission after the build-up time, and thus eliminate the need for an external trigger unit.

For such operation, there is a certain amount of time jitter: the initiation of the first spike is based on spontaneous emission, which is a random effect. However, given that the first spike depletes the gain, the amount of energy in this spike is determined by the pump, and is thus reproducible from pulse to pulse.

One object of the invention is to provide a super continuum light source comprising a non-linear optical fiber and a pump pulse source comprising the laser system according to this invention, wherein said laser system is arranged to launch said pump pulses into said non-linear fiber in such a way as to generate a super continuum in the non-linear fiber.

In this way, an economical and mechanically simple super continuum light source may be achieved, where all optical components may be fiber coupled, thus eliminating the need for e.g. free space optics. This improves the stability of the source with respect to mechanical disturbances.

One object of the invention is to provide a method for generating a pulsed laser signal with a laser signal wavelength and a laser signal repetition rate. The method comprises providing a laser system comprising a fiber laser unit comprising a cladding pumped fiber laser comprising a fiber laser light guiding region surrounded by a pump cladding. The fiber laser light guiding region comprises at least one active element. The laser system further comprises at least one pump laser unit for launching a pump signal into said cladding pumped fiber laser. The pump signal unit comprises at least one pump diode emitting a signal at a pump signal wavelength. The method further comprises modulating said pump signal unit and/or said pump signal in such a manner that the energy of the individual laser pulses of said pulsed laser signal is substantially confined to the leading pulse of relaxation oscillations of said cladding pumped fiber laser generated in response to each pump pulse.

One object of the invention is to provide a method for generating a super continuum signal comprising providing a non-linear optical fiber, providing a pump pulse source comprising the laser system according to the invention, and launching said pump pulses into said non-linear fiber in such a way as to generate a super continuum in the non-linear fiber.

In one embodiment of the invention, the substantial confinement of the energy of the individual laser pulses of the pulsed laser signal to the leading pulse of the relaxation oscillation of the cladding pumped fiber laser generated in response to each pump pulse is achieved by modulating the pump signal unit and/or the pump signal such that the pump pulse is shorter than about 1.5 period between two peaks in the relaxation oscillations, such as shorter than about 1 relaxation oscillation period such as shorter than about 0.8 relaxation oscillation period, such as shorter than about 0.5 relaxation oscillation period.

The confinement of the energy of the individual laser pulses may be such that more than about 50% of said energy is generated in said leading pulse, such that more that about 60% of said energy is generated in said leading pulse, such that more that about 70% of said energy is generated in said leading pulse, such that more that about 80% of said energy is generated in said leading pulse, such that more that 90% of said energy is generated in said leading pulse, such that more that 95% of said energy is generated in said leading pulse.

In this way, the reproducibility from pulse to pulse is improved, since the majority of the pump generated power stored in the cladding pumped fiber laser is depleted by the leading pulse. Thus, the energy of each pulse in a pulse train output from the laser system is determined by the energy of the pump pulses.

The energy of each pump pulse may be substantially coupled into the cladding pumped fiber laser in a period of time that is shorter than a maximum period of time, said maximum period of time being one order of magnitude smaller than the excited state lifetime of said active element, such as two orders of magnitude smaller than the excited state lifetime of said active element, such as three orders of magnitude less than excited state lifetime of said active element, such as four orders of magnitude less than excited state lifetime of said active element.

In this way, it may be ensured that the pump power is substantially coupled into the leading pulse and that the coupling to subsequent pulses may be suppressed.

The energy of each pump pulse may substantially be coupled into the cladding pumped fiber laser on a time scale that is shorter than about 100 μs, such as shorter than about 50 μs, such as shorter than about 10 μs, such as shorter than about 1 μs, such as shorter than about 100 ns, such as shorter than about 10 ns.

In this way, it may be ensured that the pump power is substantially coupled into the leading pulse and that the coupling to subsequent pulses may be suppressed.

In one embodiment of the laser system, the fiber laser unit comprises a Master Oscillator unit comprising at least a first Master Oscillator reflective element, and a second Master Oscillator reflective element, wherein said first Master Oscillator reflective element is arranged closer to said pump signal unit than said second Master Oscillator reflective element, and wherein the distance between said first and second Master Oscillator reflective elements defines a Master Oscillator cavity length L_{MO}.

In this way, the photon life time of the cavity may be tuned by modifying the Master Oscillator cavity length.

The first Master Oscillator reflective element may have reflection coefficient R_{MO,RE,1} at said laser signal wavelength which is in the range of about 80% to 100%, such as in the range of 90% to 100%, such as in the range of 95% to 99% and wherein said second Master Oscillator reflective element has a reflection coefficient R_{MO,RE,2} at said laser signal wavelength, which is below about 50%, such as below about 40%, such as below about 30%, such as below about 20%, such as below about 10%, such as below about 8%, such as below about 5%, such as below about 1%.

In this way, the photon life time of the cavity may be tuned by modifying the reflection coefficient of the first Master Oscillator reflective element and/or the second Master Oscillator reflective element.

The first Master Oscillator cavity length may be less than about 10 m, such than less than 5 m, such than less than 2 m, such than less than 1 m, such than less than 0.5 m, such as less than 0.1 m.

The first Master Oscillator cavity length may be such that the photon lifetime is below about 1 μs, such as below about 500 ns, such as below about 250 ns, such as below about 100 ns, such as below about 50 ns, such as below about 10 ns, such as below about 5 ns, such as below about 1 ns.

The Full Width Half Maximum spectral width of the reflection spectrum of said first Master Oscillator reflective element, and/or of the reflection spectrum of said second Master Oscillator reflective element and/or of their combined reflection spectrum may be in the range of about 0.1 nm to about 100 nm, such as in the range of about 0.2 nm to about 50 nm, such as in the range of about 0.4 nm to about 10 nm, such as in the range of about 0.6 nm to about 5 nm, such as in the range of about 0.8 nm to about 1.5 nm.

In one embodiment, the laser system comprises a tuning unit arranged to actively control the spectral position of the reflection of at least one of said first and second Master Oscillator reflective elements, such as a thermal control or a longitudinal stretching of the Master Oscillator reflective element(s).

In one embodiment, the laser system comprises at least one optical coupler arranged to couple said pump signal into said cladding pumped fiber laser, such as an 1×2 optical coupler, an 1×4 optical coupler, an 1×7 optical coupler, an 6+1×1 optical coupler, an 7+1×1 optical coupler, an 1×19 optical coupler, an 1×37 optical coupler, an 1×61 optical coupler.

In one embodiment, the modulating unit is capable of modulating an electrical supply current provided to the at least one pump laser unit. In this way, the modulating unit may be realized e.g. as a driver electronic circuit, thus achieving a particularly simple optical system.

The active element may comprise Bismuth (Bi) or a Rare Earth element selected from the group of Ytterbium (Yb), Erbium (Er), Praseodymium (Pr), Neodymium (Nd), Holmium (Ho), Thulium (Tm), Dysprosium (Dy), or combinations thereof.

In one embodiment, the fiber laser further comprises a Power Amplifier unit arranged to amplify the pulsed laser signal generated in said Master Oscillator.

A Master Oscillator-Power Amplifier (MOPA) configuration allows a tailoring of the pulse properties, such as pulse width, via the cavity design independent of the pulse energy. The pump energy not absorbed in the Master Oscillator will be absorbed in the Power Amplifier.

In one embodiment, the cladding pumped fiber laser comprises a fiber with a reduced modal overlap between the laser signal guided in the fiber laser and the active element, such as below 25%, such as such as below 20%, such as below 15%, such as below 10%, such as below 5%, such as below 1%.

The laser signal repetition rate may be in the range of about 0.1 Hz to about 500 kHz.

Alternatively, the laser signal repetition rate may be in the range of about 1 kHz to about 1 MHz, such as from about 50 kHz to about 500 kHz, such as from about 80 kHz to about 150 kHz.

According to an aspect of the invention a fiber laser, optionally being according to any of the abovementioned embodiments, is adapted to facilitate lasing at a first Raman wavelength, λ_{R,1}, which is Stoke shifted from said laser signal wavelength. The laser system may comprise at least a first Raman cavity comprising two first Raman cavity reflective elements, wherein said first Raman cavity is arranged to provide Raman lasing/amplification at said first Raman wavelength. The laser system may comprise a second Raman cavity comprising two second Raman cavity reflective elements, wherein said second Raman cavity is arranged to transfer energy from said first Raman wavelength to a second Raman wavelength λ_{R,2} where λ_{R,2}>λ_{R,1}. The laser system may comprise further Raman cavities arranged to transfer energy into signals at further Raman wavelengths, such as a third Raman wavelength and a fourth Raman wavelength, in a cascaded Raman laser arrangement. In an arrangement comprising a plurality of Raman cavities, the Stoke shift of signals from one wavelength to another may be partial or substantially complete, such that the lasing signal may be more or less evenly distributed over several Raman wavelengths or such that the lasing signal is substantially at one Raman wavelength. Additionally, a residual part of the laser signal may remain at the laser signal wavelength, such that light at both the laser signal wavelength and one or more Raman wavelengths may be generated. In the context of the present application, the phrase substantially at one Raman wavelength refers to the situation where more than about 50% of the laser signal energy is at this one Raman wavelength, such as 60%, such as 70%, such as 80%, such as 90%, such as 95%, such as 98%.

In this way, a fiber laser system may be achieved which is capable of emitting laser light at a multitude of wavelengths simultaneously.

At least one of said Raman cavity reflective elements may be arranged in between said first and second Master Oscillator reflective elements.

In one embodiment, the fiber laser light guiding comprises a material with high Raman gain, such as a material with a Raman gain in the range 10⁻¹³ m/W to 10⁻¹⁰ m/W at said laser signal wavelength. The material with high Raman gain may comprise germanium in a molar concentration (counting oxygen) in the range of about 0.1% to about 5%, such as in the range of about 0.5% to about 3%, such as in the range of about 0.7% to about 2%, such as in the range of about 0.8% to about 1.5%.

In one embodiment, the fiber laser light guiding region comprises a photosensitive region.

In this way, reflective elements such as the first and second master oscillator reflective elements may be conveniently formed directly in the cladding pumped laser fiber, e.g. as gratings formed by the well-known process of UV-writing. Thus, the master oscillator including reflective elements may be achieved in a single fiber, which may reduce oscillator losses, improve the stability of the oscillator with regards to vibration, etc.

The Master Oscillator and the Power amplifier may be monolithic integrated in one fiber. This is for instance the case when the fiber laser light guiding region comprises a photosensitive region

In one embodiment, the pulsed laser signal from the laser system is coupled via a fusion splice to said non-linear fiber such as to provide a monolithic, all-fiber, super continuum source.

In this way, a particularly convenient and economical super continuum source may be achieved. Furthermore, the monolithic, all-fiber embodiment of the source may have an improved stability with regards to vibrations, etc.

The non-linear fiber may be selected from the group of a microstructured optical fiber, a conventional optical fiber, a graded index fiber, a multimode fiber, or a single mode.

In one embodiment of said super continuum light source, at least a section of said non-linear fiber is tapered to an outer diameter that is smaller or larger than the outer diameter of the non-linear fiber prior to the tapering.

In one embodiment, the method comprises actively controlling the spectral position of the reflection of at least one of said first and second Master Oscillator reflective elements, such as by heating, cooling, or longitudinal stretching said Master Oscillator reflective element(s).

In one embodiment of the method according to the invention, the laser system of the method comprises the laser system as claimed and/or described in the present document.

The pulsed laser signal from the laser system may be coupled via a fusion splice to said non-linear fiber such as to provide a monolithic, all-fiber, super continuum source.

The Master Oscillator may be designed to give as short pulses as possible (short length and low Q-factor).

With proper design of the control electronics for the modulating unit a similar performance in terms of spectral density may be reached by pumping with a single modulated high power pump diode, such as the Oclaro BMU25 device. Such improvement may rely on: Optimization of pump pulse (Increased slew rate), optimization of cavity (Lower Q), optimize cavity length), optimized NL fiber (Length, tapering).

In the experiments described in Example 1, the delays observed from pump-on to lasing are in the order of 5-10 μs. Duration of pump pulses should therefore preferably be shorter than this. Aiming for dumping as much power as possible in a 5 μs window should therefore be a target of development.

Another subject of investigation should be optimization of cavity design. One way of increasing pulse energy is to lower the Q-factor of the cavity. This way threshold is increased and more energy is stored in the cavity prior to pulsing. Also, pulse width of the relaxation oscillation should be minimized in order to increase peak power. This relates to minimizing the photon lifetime of the cavity which also ties into the length and Q-factor of the cavity.

Finally optimization of the non linear fiber could help to enhance the process of generating a super continuum. One suggestion which has been proposed is to use a tapered nonlinear fiber where the zero dispersion point gradually is blue shifted toward the visible.

In one embodiment, at least a section of said non-linear fiber is tapered to an outer diameter that is smaller or larger than the outer diameter of the non-linear fiber prior to the tapering. This tapering allows for changing the dispersion properties of the NL fiber and to shift the zero dispersion wavelength towards e.g. a shorter wavelength.

The following description of the photon life time in a laser cavity is a summary of the theory section provided by “Principles of lasers” 3^{rd} edition page 258-263, Svelto and Hanna, Plenum.

Consider a cladding pumped fiber laser with a cavity of length L, high reflector reflectivity of 100% and an output coupler with a reflectivity R.

In the context of the present invention, the phrases “Output coupler” and “second Master Oscillator Reflective element” are used interchangeably. In the context of the present invention, the phrases “high reflector coupler” and “first Master Oscillator Reflective element” are used interchangeably.

Assuming round trip loss in the cavity is given only by the gratings, the photon life time of the cavity is given by:

τ_{c}=−2[L*n]/[c ln(R)]

where n is the refractive index of the material and c is the speed of light in vacuum. Consider a system in which a short pump pulse has excited at lot of active ions into the excited state but laser action has not yet built up. In this state the population inversion can be much higher than the value of the CW laser threshold while the photon density in the cavity is still very low. With such initial condition the following relations can be derived correlating the pulse width of the leading pulse of the relaxation oscillations, Δτₚ to the photon life time, τ_{c} and the initial level of inversion

Δτₚ=τ_{c}·η_{E}·G(Nᵢ/Nₚ)

where Nᵢ and Nₚ are the initial population density of the excited state and the excited state density at peak intensity (round trip gain=0 i.e. equal to critical inversion)) η_{E} is the power extraction efficiency of energy from the system by the first pulse given by:

η_{E}=(Nᵢ−N_{f})/Nₚ

where N_{f} is the final population of the excited state after the pulse has died out, i.e. η_{E} is close to unity.

G(Nᵢ/Nₚ) is given by:

G(Nᵢ/Nₚ)=Nᵢ/Nₚ·[Nᵢ/Nₚ−ln(Nᵢ/Nₚ)−1]⁻¹

From the equations above it follows that the pulse width is proportional to the photon life time with a proportionality constant given by the amount of energy which is stored in the system prior to build up of laser action.

In order to obtain a narrow pulse width it is therefore essential to design the cavity in order to minimize the photon life time. Such optimization relates directly to limiting the length of the cavity and lowering the reflectivity of the output coupler.

The inventor of the present application has realized that photonic crystal fibers (PCFs) are generally well suited for such optimization. Due to the large core sizes and high NA cladding pump absorption can be very high which means that device length can be reduced.

In the following descriptions and examples, a high fiber laser is used, which is referred to as an “Aerolase 350 laser”. The Aerolase 350 laser is an all-fiber laser with up to 350 W output power when run in CW operation. If desired, the Aerolase 350 laser can be gain switched to obtain pulsed light.

### BRIEF DESCRIPTION OF DRAWINGS

The invention will be explained more fully below in connection with a preferred embodiment and with reference to the drawings in which:

FIG. 1 shows an experimental setup of the laser system,

FIG. 2a shows the power of the super continuum light source vs. driving current of the 18 pump diodes running in CW mode,

FIG. 2b shows part of the output spectrum from the super continuum light source at low, medium and high pump power (6 A, 8 A and 10 A pump drive current) and run in CW mode,

FIG. 3 shows a spectrum measured with integrating sphere,

FIG. 4 shows temporal dynamics of the output from the Non-Linear (NL) fiber at 3 A pump current, which is the laser threshold (left) and at 6 A pump current (right),

FIG. 5 shows optical spectra recorded every 20 min during 2 h continuous CW operation with 42 W Super Continuum output power,

FIG. 6 shows the standard deviation of all the plots shown in FIG. 5,

FIG. 7 shows temporal dynamics of the generated continuum when operating the pump lasers in pulsed mode with a repetition rate of 100 Hz and the pump is modulated from 0 to 6 A,

FIG. 8 shows a sketch of a gain switched Super continuum source. Relaxation oscillation from the Aerolase 350 laser is used to pump the non-linear fiber,

FIG. 9 shows Average pump power from 16 BMU10 (Oclaro) diodes vs. control voltage,

FIG. 10 shows a comparison of the super continuum generated with an Aerolase 350 laser running in CW mode (red and blue) and operating in pulsed mode,

FIG. 11 shows a comparison of the visible part of the spectrum generated with the Aerolase 350 laser (left) and the SuperK Extreme device, and

FIG. 12 shows an experimental setup of an optimized laser system.

The figures are schematic and may be simplified for clarity. Throughout, the same reference numerals are used for identical or corresponding parts.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

The invention is defined by the features of the independent claim(s). Preferred embodiments are defined in the dependent claims. Any reference numerals in the claims are intended to be non-limiting for their scope.

Some preferred embodiments have been shown in the foregoing, but it should be stressed that the invention is not limited to these, but may be embodied in other ways within the subject-matter defined in the following claims.

### EXAMPLE 1

Results are presented on generation of super continuum in a nonlinear fiber pumped with an “Aerolase 350”, high power fiber laser from NKT Photonics. Pure CW results are presented as well as results on peak power enhancement of the laser via gain switching.

The test device consists of 16 to 18 pump diodes (Oclaro, BMU10), a fiber laser (Aerolase 350) and a length of super continuum generating optical fiber (nonlinear fiber). All the elements are fusion spliced together.

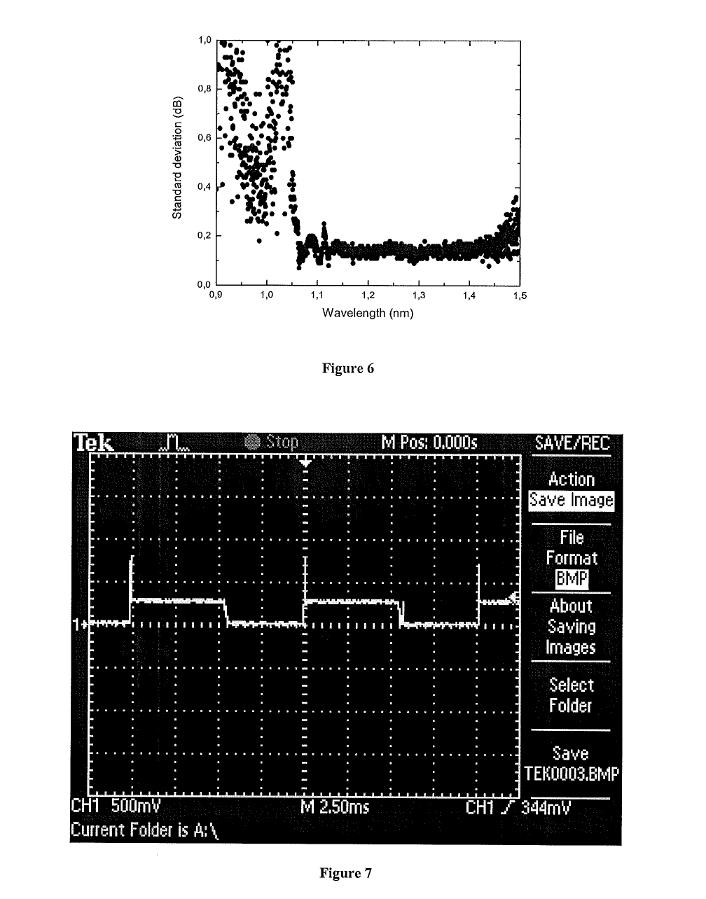

In the CW regime optical spectra are obtained with up to 42 W average output power from a monolithic all-fiber device. The device distributes the power in the range from 1064 nm to 1500 nm with an average spectral density estimated to be around 80-90 mW/nm. In addition visible light is generated in the NIR region from 800 nm-1060 nm with a spectral density estimated to be around a few mW/nm. Good spectral stability of the device was observed in a 2 h test. In the wavelength range from 1050 nm to 1500 nm, power fluctuations were observed to be less than 0.2 dB. This can be seen in FIG. 6.

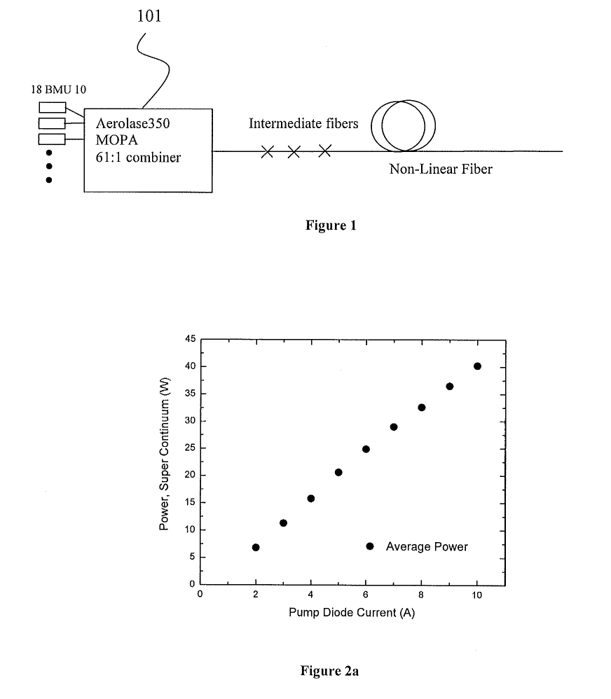

The setup used is as sketched in FIG. 1. An Aerolase 350 CW laser 101 pumped via a 61:1 combiner was used to pump a nonlinear fiber. 18 BMU10 diodes are used to pump the Aerolase 350 CW laser 101. The Aerolase 350 CW laser 101 is spliced to a nonlinear fiber via a Nufern FUD3539 fiber with a 15 μm core and a Nufern UHNA1 thermally expanded core (TEC) fiber with a 3.4 μm core before TEC.

The nonlinear fiber has a d/Λ=0.5 and an assumed zero-dispersion at 1060 nm. OH loss around 1400 nm is measured to be around 25 dB/km while the background loss in the range from 800-1600 nm is below 5 dB/km. The estimated Mode Field Diameter of the fiber is around 4 μm.

The splice loss from the Aerolase 350 CW laser 101 to the nonlinear fiber is estimated to be 1.2 dB total.

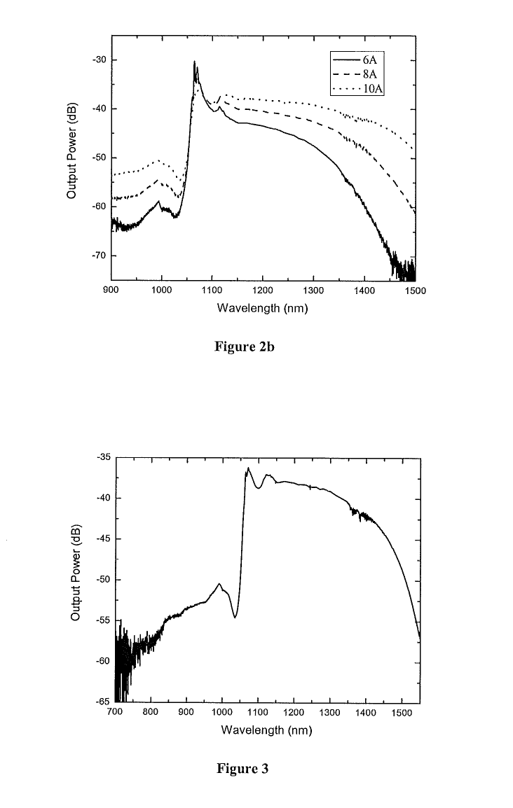

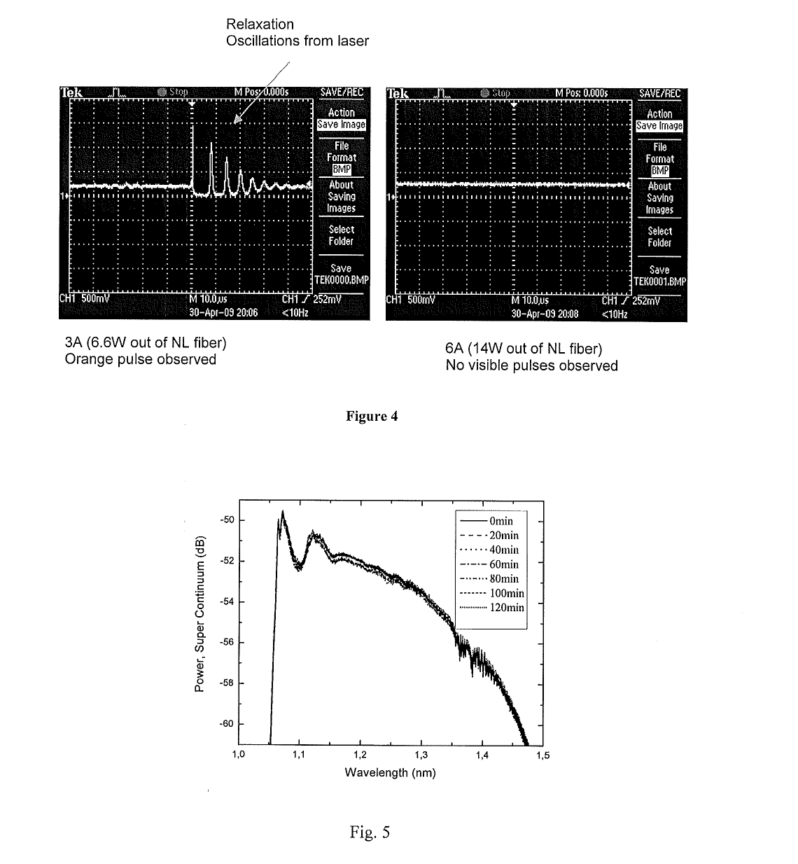

In FIG. 2b, the spectrum for low, medium and high pump power can be seen. It is noted that the optical spectrum is very broad and there is significant more power in the NIR part of the spectrum (from 1040 nm to 1500 nm) than towards the visible region (below 1000 nm).

In FIG. 3 the spectrum for 42 W of super continuum output (55 W pump) is shown. As can be seen from the spectrum the power of the pump is almost completely distributed over the region from 1060 nm to 1500 nm. The average spectral density in this window is estimated to be 42 W/440 nm i.e. ˜90 mW/nm. In the range from 800 nm to 1000 nm light is also generated. The level seems to be approx 15 dB down relative to the average level in the 1060-1500 nm window. An estimate of average power density in this window is therefore a few mW/nm.

At 42 W output power visible red light is observed out of the NL fiber. Contrary, reducing the operating power of the fiber laser close to threshold bright orange light is observed out of the NL fiber. The orange light seems to be correlated with relaxation oscillations of the fiber due to self pulsing instabilities in this regime. At higher powers (power well above lasing threshold), the Aerolase laser is stable and no temporal variations are observed as seen in FIG. 4. Left graph in FIG. 4 shows the relaxation oscillations, where one object of the present invention is to launch pump power into the leading pulse. The relaxation oscillations around threshold are correlated with bright orange light from the NL fiber. At high pump current the relaxation oscillations are heavily damped.

A first attempt to characterize the spectral stability of the source was made. Results of a test running for two hours with spectral data being recorded every 20 min are shown in FIG. 6. The laser was operated at 55 W output power launched into the nonlinear fiber. An output of 42 W super continuum was observed. A fraction of the super continuum was picked up using an integrating sphere to couple the light into a multimode fiber.

The electronic driver used to run the experiments on the super continuum light source described above can only provide modulation with a rep rate of 100 Hz and a duty cycle of 50%. In FIG. 7 is shown the temporal dynamics of the super continuum light source when modulating the pump laser from 0-6 Amp. If the fiber laser runs CW no visible light exits the fiber. If, however, the fiber laser unit is modulated bright pulsing orange light comes out of the laser presumably correlated with the transients shown in FIG. 7. Initial relaxation oscillations of the Aerolase350 laser are observed.

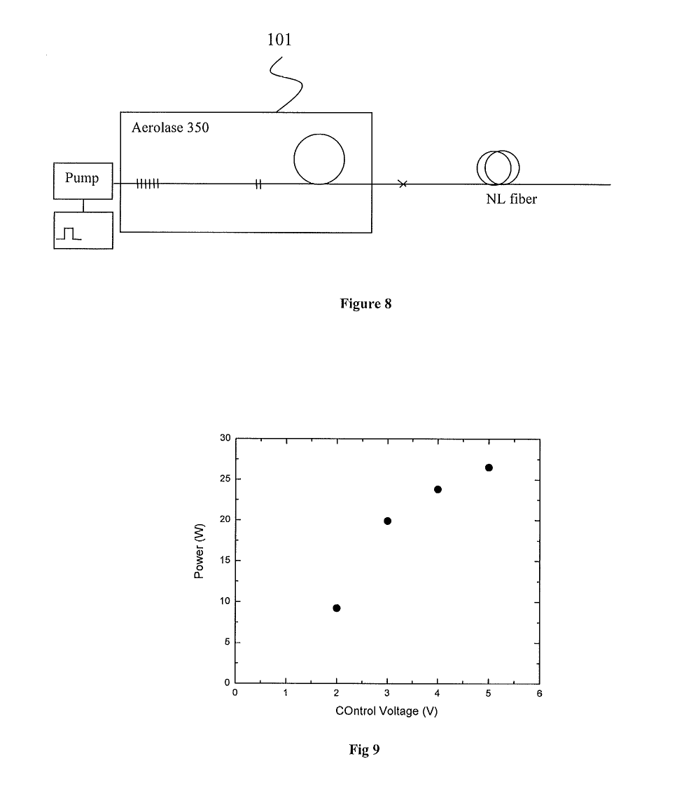

In order to use this effect to build an economical high power continuum source the laser may be run with a modulated pump power with rep. rates in the range of 50 kHz and a duty cycle of e.g. 50% (i.e. 10 μs pulses). A laser system as sketched in FIG. 8 could be envisioned. Such a laser system may be robust and manufacturable and may be designed with most of the components as an all fiber system.

### EXAMPLE 2

In this example, further optimized electronics is used. A gain switched Aerolase 350 CW laser was realized in which the pump pulse was adjusted to isolate the leading pulse of the relaxation oscillations. The module was pumped with 16 BMU10 diodes modulated from 0-5 A. The total average power of the light coming out of the laser was 7.3 W. From this the peak power is estimated to be around 500 W and pulse energy around 160 μJ. A sketch of the setup can be seen in FIG. 8.

The pump diodes used to realize the pulse train described above was subsequently spliced to 16 ports of the 61:1 combiner of the Aerolase 350 CW 101. This way the setup shown in FIG. 1 could be operated CW with 18 diodes all-ready attached, or gain switched via 16 diodes from a module. Launching the pulse train into the nonlinear fiber generated a broad super continuum ranging from 550 nm to beyond 1700 nm (limit of OSA) with an average total power of 5 W. In terms of spectral width this is similar to what was achieved with a NKT Photonics SuperK pump source for the specific fiber used.

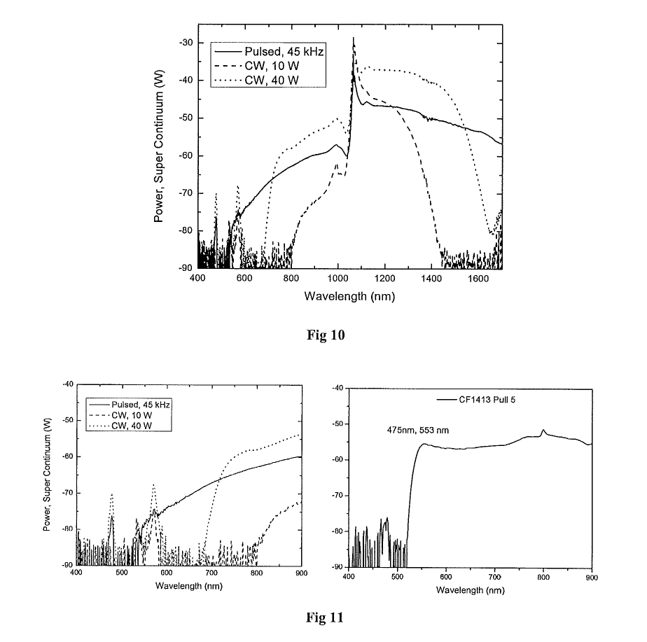

In FIG. 10 the spectral output from the setup is compared for the laser operating CW mode with 18 diodes or gain switched with 16 modulated diodes. As seen from the plot a significant broadening of the spectrum is found in gain switched mode compared to the CW.

It is noted that the 1064 nm light from the Aerolase 350 laser pumping the nonlinear fiber is completely depleted in the 40 W CW case while there is still a significant amount of fiber laser pump light available in the gain switched case. This is even though the peak intensity in the latter case is much higher than in the first. The result may indicate that not only peak power but also average power plays a role in optimizing the efficiency of continuum generation.

In FIG. 11 the visible part of the spectrum is compared with the visible part of the spectrum obtained pumping the NL fiber with a SuperK Extreme pump source. The latter is a commercially available super continuum light source developed at NKT Photonics A/S. In the case where the Aerolase 350 laser is pumped with pulses, very clear orange light is emitted from the Non-linear fiber device. As can be seen from the plot the continuum generated with the gain switched laser includes light with wavelengths extending all the way down to the same wavelengths reached with the SuperK Extreme light source. It is noted that the optical powers observed are significantly different.

In summary the feasibility of gain switching the Aerolase 350 laser is demonstrated. By tailoring the pump pulse the leading pulse of the relaxation oscillations was isolated to yield a low jitter train of pulses with a rep. rate for 45 kHz and average power of 5 W.

Pumping a non-linear fiber with such pulses demonstrates the feasibility of generating super continuum spanning the whole spectral range supported by the fiber using a Aerolase 350 laser.

This Example shows that a monolithic supercontinuum light source based on an Aerolase 350 laser in combination with a NL fiber is feasible. In CW mode a very powerful IR spectrum can be achieved while generation of visible light relies on peak power enhancement by gain switching the Aerolase 350 laser.

From an application point of view the gain switched solution is interesting. This solution potentially spans the whole visible and near-IR spectrum and limits the amount of excess light which needs to be handled in a system.

One limitation of the system described in this Example is the limited slew rate of the current driving the pump diodes. Switching on the pump there is a delay until laser action builds up in the Aerolase 350 laser. In Ytterbium lasers it is generally the case that the lifetime of the upper laser level is much longer than the photon lifetime in the cavity (˜1 ms). In such cases it is possible to build inversion well beyond the threshold level prior to laser action. In this way energy is stored in the system. It should be the aim of further development to optimize the amount of energy stored.

Prior to splicing to the aerolase350 fiber laser, the 16 diodes were characterized. Average pump power vs. control voltage is shown in FIG. 9. Above 5V (˜5 A peak current) so-called power roll-over can be seen. This roll-over is attributed to temporal limitation of the pump drive circuit, which can be seen as a limited slew rate of the driving current.

### EXAMPLE 3

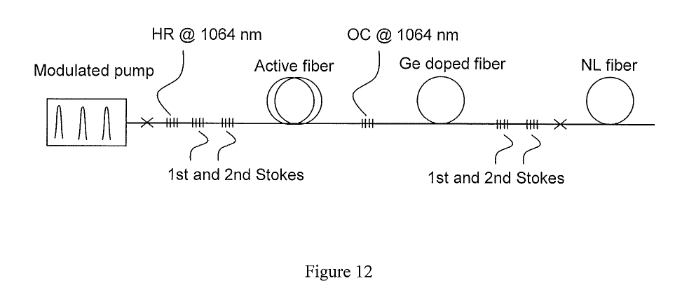

One embodiment of the cladding pumped fiber laser device is shown in FIG. 12. The active fiber has a photosensitive core which allows for UV written Bragg gratings to be imprinted into the core. This way fiber lasers in MOPA configurations can be realized in a single piece of fiber. The outer diameter of the fiber is 125 μm and the inner cladding diameter is 105 μm. The diameter of the core is 10 μm and composed of the same material as the fiber used in Example 1.

Such a fiber is estimated to have a pump absorption which is 5 times higher than the fiber used in Example 1. The length of the master oscillator can therefore be reduced by this factor as well. In example 1 the reflectivity of the output coupler is 20%. In this embodiment it is reduced to 10%. The reduction in length and reflectivity combines to reduce the photon lifetime τ_{c} from around 40 ns in Example 1 to around 6 ns in this embodiment according to the abovementioned equation for the photon lifetime.

If the same amount of energy is stored in the fiber prior to laser buildup this embodiment should, according to equation for the pulse width Δτₚ, result in pulses 7 times narrower (around 40 ns) and hence with 7 times higher peak power (around 2-3 kW).

In one embodiment of the laser system may be based on an active photosensitive core with an outer diameter of 125 μm, a 105 μm inner cladding diameter, and a 8-10 μm core diameter. Such a device could be directly spliced to e.g. a BMU25 diode from Oclaro eliminating the need for a pump combiner.

1. (canceled)

2. (canceled)

3. (canceled)

4. (canceled)

5. A laser system arranged to generate a pulsed laser signal with a and a laser signal repetition rate, said laser system comprising
a fiber laser unit comprising a cladding pumped fiber laser comprising a fiber laser light guiding region surrounded by a pump cladding, said fiber laser light guiding region comprising at least one active element;
at least one pump laser unit arranged to launch a pump signal into said cladding pumped fiber laser, said pump laser unit comprising at least one pump diode arranged to emit said pump signal at a pump signal wavelength; and
a modulating unit arranged to modulate said pump signal into a plurality of pump pulses each arranged to generate relaxation oscillations in the laser action of said cladding pumped fiber laser, said relaxation oscillations each having a leading pulse wherein said laser system is arranged so the initiation of each leading pulse of said relaxation oscillations is based on spontaneous emission where said modulating unit is arranged to modulate said pump signal such that the energy of the individual laser pulses of said pulsed laser signal is substantially confined to said leading pulses.

6. The laser system according to claim 5, wherein the confinement of the energy of the individual laser pulses is such that more than about 50% of said energy is generated in said leading pulse.

7. The laser system according to claim 5, wherein the energy of each pump pulse substantially is coupled into the cladding pumped fiber laser in a period of time that is shorter than a maximum period of time, said maximum period of time being two orders of magnitude smaller than the excited state lifetime of said active element.

8. The laser system according to claim 5, wherein the energy of each pump pulse is coupled into the cladding pumped fiber laser substantially in a period of time that is shorter than a maximum period of time, said maximum period of time being shorter than about 0.8 period between two peaks in the relaxation oscillations of the fiber laser.

9. The laser system according to claim 5, wherein the energy of each pump pulse is coupled into the cladding pumped fiber laser substantially on a time scale that is shorter than about 10 μs.

10. (canceled)

11. (canceled)

12. (canceled)

13. (canceled)

14. (canceled)

15. (canceled)

16. (canceled)

17. The laser system according to claim 5, wherein the modulating unit is arranged to modulate an electrical supply current provided to the at least one pump laser unit.

18. The laser system according to claim 5, wherein said active element comprises a Rare Earth element selected from the group of Ytterbium (Yb), Erbium (Er), Praseodymium (Pr), Neodymium (Nd), Holmium (Ho), Thulium (Tm), Dysprosium (Dy), and combinations thereof.

19. The laser system according to claim 5, wherein said fiber laser unit comprises a Master Oscillator unit, said fiber laser further comprises a Power Amplifier unit arranged to amplify the pulsed laser signal generated in said Master Oscillator and the Master Oscillator and the Power amplifier unit are monolithically integrated in one fiber.

20. (canceled)

21. The laser system according to any of the claim 5, wherein said cladding pumped fiber laser comprises a fiber with a reduced modal below 25% overlap between the laser signal guided in the fiber laser and the active element.

22. (canceled)

23. The laser system according to claim 5, wherein said fiber laser light guiding region comprises a photosensitive region.

24. The laser system according to claim 5 wherein said fiber laser is adapted to facilitate lasing at a first Raman wavelength, λ_{R,1}, which is Stoke shifted from said laser signal wavelength.

25. The laser system according to claim 24, further comprising at least a first Raman cavity comprising two first Raman cavity reflective elements, wherein said first Raman cavity is arranged to provide Raman lasing/amplification at said first Raman wavelength and said laser system further comprising a second Raman cavity comprising two second Raman cavity reflective elements, wherein said second Raman cavity is arranged to transfer energy from said first Raman wavelength to a second Raman wavelength λ_{R,2} where λ_{R,2}>λ_{R,1}.

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. A super continuum light source comprising a non-linear optical fiber and a pump pulse source, said pump pulse source comprising the laser system according to claim 5, wherein said laser system is arranged to launch said pump pulses into said non-linear fiber in such a way as to generate a super continuum in the non-linear fiber.

44. The super continuum light source according to claim 43, wherein said non-linear fiber is selected from the group of a microstructured optical fiber, a conventional optical fiber, a graded index fiber, a multimode fiber, or a single mode.

45. The laser system according to claim 5 wherein the pump signal is turned off at the time of the leading pulse.

46. A system for gain switching of a cladding pumped fiber laser device arranged to generate a pulsed laser signal with a laser signal wavelength and a laser signal repetition rate said system comprising
at least one pump laser unit arranged to launch a pump signal into said cladding pumped fiber laser, said pump laser unit comprising at least one pump diode arranged to emit said pump signal at a pump signal wavelength; and
a modulating unit arranged to modulate said pump signal into a plurality of pump pulses each arranged to generate a leading pulse of a set of relaxation oscillations in the laser action of said cladding pumped fiber laser,
wherein said laser system is arranged so the initiation of each leading pulse is based on spontaneous emission and said pump pulses are arranged so their individual pulse energy is substantially coupled into said leading pulse.

47. The laser system according claim 46 wherein the pump signal is turned off at the time of the leading pulse so that only one pulse is emitted per pump pulse.

48. The laser system according to claim 46, wherein the energy of each pump pulse substantially is coupled into the cladding pumped fiber laser in a period of time that is shorter than a maximum period of time, said maximum period of time being two orders of magnitude smaller than the excited state lifetime of said active element.

49. The laser system according to claim 46, wherein said fiber laser device comprises a gain medium comprising an active element said active element comprises Ytterbium (Yb).

50. The laser system according to claim 46, wherein said fiber laser device comprises a gain medium comprising an active element said active element comprises Erbium (Er)

51. The laser system according to claim 46, wherein said fiber laser device comprises a gain medium comprising an active element said active element comprises Thulium.

52. The laser system according to claim 46, wherein said fiber laser unit comprises a Master Oscillator unit, said fiber laser further comprises a Power Amplifier unit arranged to amplify the pulsed laser signal generated in said Master Oscillator and the Master Oscillator and the Power amplifier unit are monolithically integrated in one fiber.
